(19) United States
(12) Patent Application Publication
(10) Pub. No.: US 2013/0272642 A1
(43) Pub. Date: Oct. 17, 2013

(54) SPACER AND ROTARY CONNECTION APPARATUS USING THE SAME

(71) Applicants: HONG FU JIN PRECISION INDUSTRY (ShenZhen) CO., LTD., (US); HON HAI PRESISION INDUSTRY CO., LTD., New Taipei (TW)

(72) Inventors: GUO-FENG LI, Shenzhen (CN); YA-PING TENG, Shenzhen (CN); MENG-HUA HE, Shenzhen (CN); LI-HUA DING, Shenzhen (CN); HUI YE, Shenzhen (CN); LING-KONG WANG, Shenzhen (CN); CHUN-CHE YEN, New Taipei (TW); FENG-HSING HSIEH, New Taipei (TW)

(73) Assignees: HON HAI PRECISION INDUSTRY CO., LTD., New Taipei (TW); HONG FU JIN PRECISION INDUSTRY (ShenZhen) CO., LTD ., Shenzhen (CN)

(21) Appl. No.: 13/859,698

(22) Filed: Apr. 9, 2013

(30) Foreign Application Priority Data
Apr. 11, 2012 (CN) 201210104272.7

(51) Int. Cl. F16C 19/10

(52) U.S. Cl. CPC F16C 19/10
USPC 384/615

(57) ABSTRACT

A rotary connection apparatus comprising a bottom bracket, a top bracket rotatably connected to the bottom bracket, an annular spacer and a plurality of balls. The spacer and the balls are received between the bottom bracket and the top bracket. A thickness of the spacer is less than a diameter of the balls, and the spacer includes a plurality of holding holes, each holding hole has two openings exposed at opposite surfaces of the spacer, and a diameter of each of the openings is less than that of the balls, and a diameter of a central portion of each holding hole is equal to the diameter of the balls; each of the holding holes accommodates one corresponding ball, and each ball has opposite end portions protruding out of the spacer. A spacer is also provided.

### BACKGROUND

1. Technical Field

The present disclosure relates to spacers, particularly to a spacer preventing balls from dropping and a rotary connection apparatus using the same.

2. Description of Related Art

Rotary connection apparatus has many advantages, such as simple structure, low friction for example. The rotary connection apparatus is always used for air purifier or vertical fan to meet their rotation requirements. FIG. 9 shows that the rotary connection apparatus 900 includes a bottom bracket 91, a top bracket 92 rotatably connected to the bottom bracket 91, a annular spacer 93 and a plurality of balls 94. The top bracket 92 defines a annular slot 922, and the spacer 93 is received in the slot 922, and the spacer 93 faces the slot 922. FIG. 8 shows that the spacer 93 defines a plurality of cylindrical holes 931, and each cylindrical hole 931 merely accommodates one ball 94. While the top bracket 92 is rotating with respect to the bottom bracket 91, the balls 94 are also rolling in the slot 922 to reduce rotating friction between the top bracket 92 and the bottom bracket 91, the top bracket 92 thus rotates more smoothly with respect to the bottom bracket 91.

However, the balls 94 are solid and heavy, so the balls 94 are easily dropping from the cylindrical holes 931 while assembling. Also, defining a plurality of cylindrical holes 931 on the spacer 93 to accommodate the balls 94 is time consuming.

Therefore, what is needed is a spacer and a rotary connection apparatus using the same to overcome the above mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric and sectional view of a rotary connection apparatus in one embodiment.

FIG. 2 is an exploded view of a rotary connection apparatus shown in FIG. 1.

FIG. 3 is a cross sectional view of an assembled spacer structure taken along line shown in FIG. 2.

FIG. 4 is a cross sectional view showing the partial enlarged detail of the encircled portion IV of FIG. 3.

FIG. 5 is an isometric view of a spacer in an alternative embodiment.

FIG. 6 is an isometric view of a spacer in an alternative embodiment.

FIG. 7 is a cross sectional view of a spacer structure in another alternative embodiment

FIG. 8 is a cross sectional view showing the partial enlarged detail of the encircled portion VIII of FIG. 7.

FIG. 9 is an exploded and sectional view of a spacer in related art.

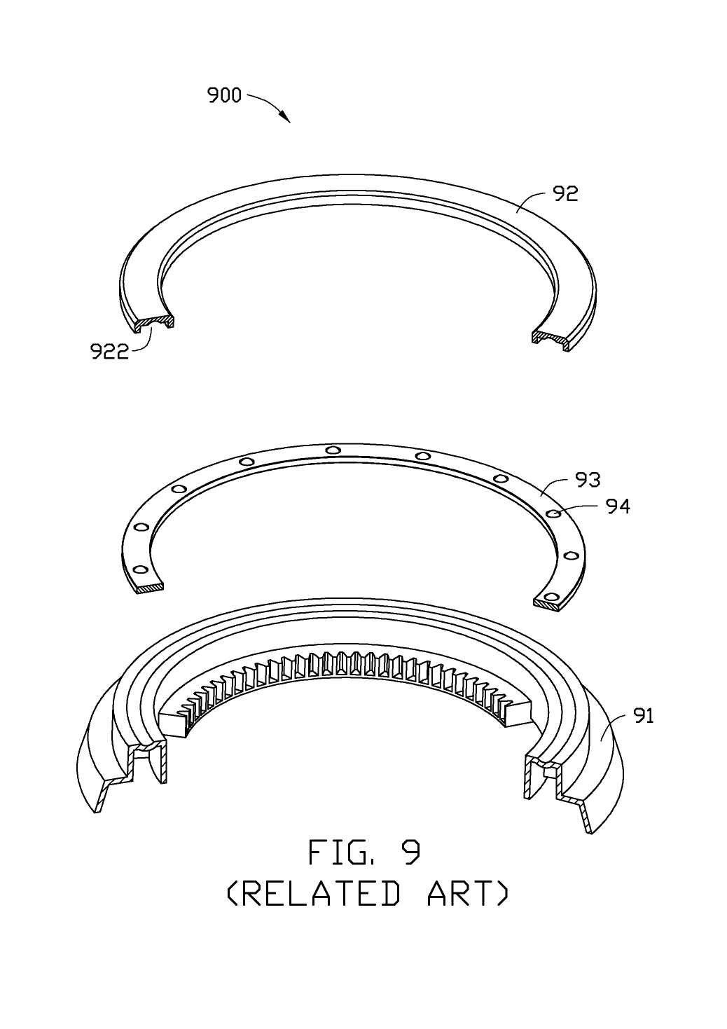

FIG. 10 shows a ball dropping from a hole of the spacer of FIG. 9.

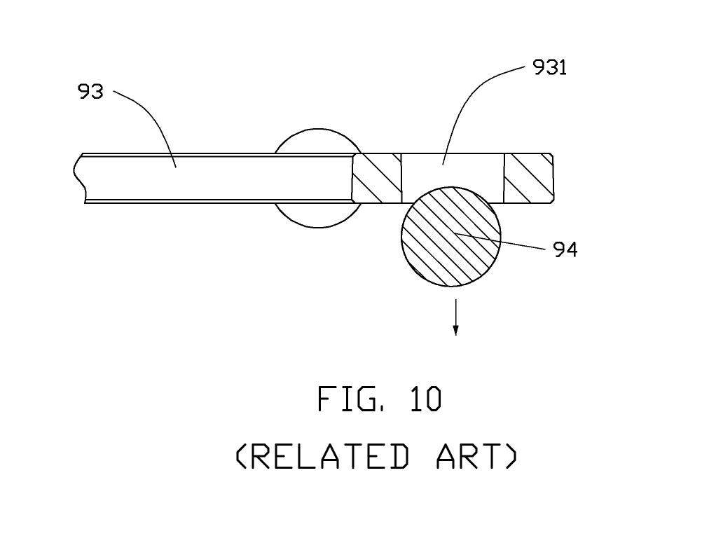

### DETAILED DESCRIPTION

The disclosure including the accompanying drawings, is illustrated by way of example and not by way of limitation. It should be noted that references to “an” or “one” embodiment in this disclosure are not necessarily to the same embodiment, and such references mean at least one.

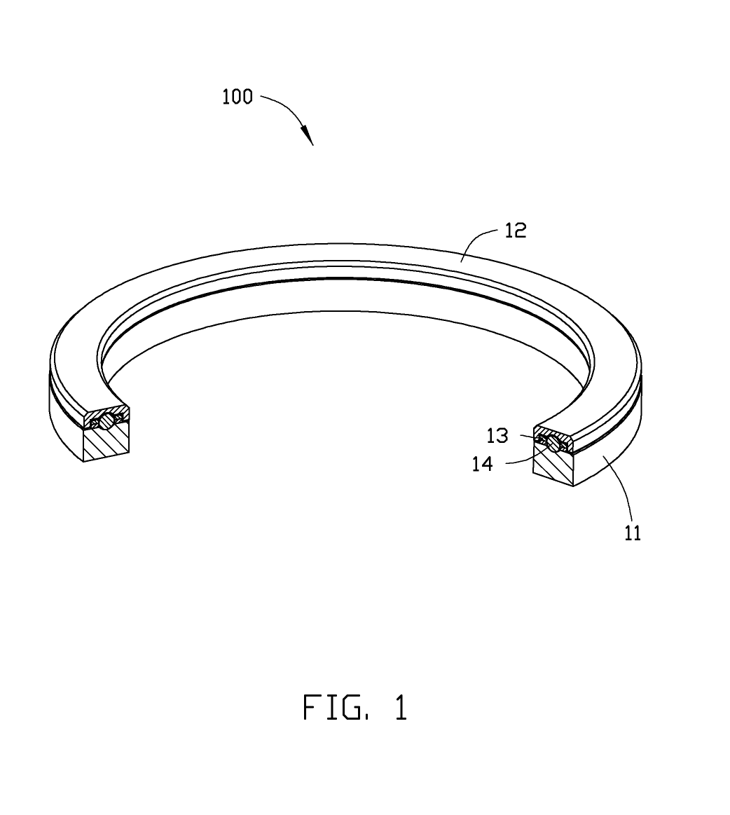

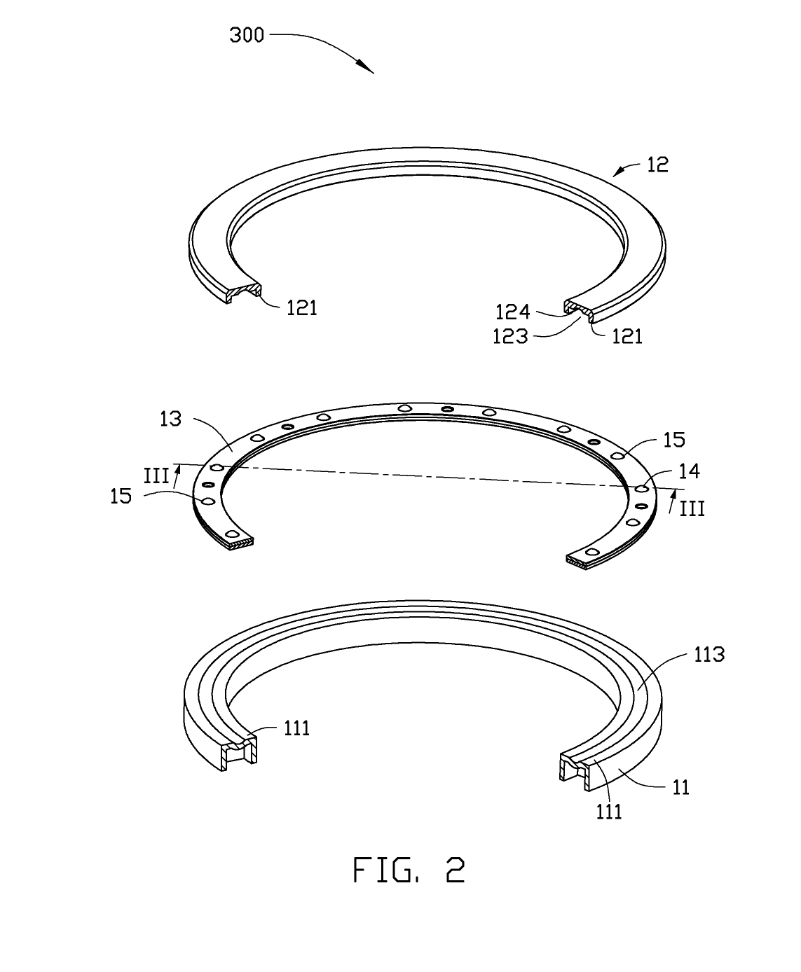

FIGS. 1 and 2 show a rotary connection apparatus 100 of one embodiment. The rotary connection apparatus 100 includes a bottom bracket 11, a top bracket 12, a annular spacer 13 and a plurality of rolling elements. In this embodiment, the rolling elements are balls 14. The top bracket 12 is rotatably connected to the bottom bracket 11. The bottom bracket 11 is fixed to a first element of a device (not shown), and the top bracket 12 is fixed to a second element of the device (not shown). Therefore, the first element of the device is rotatable with respect to the second element of the device. In this embodiment, the first element is a substructure of a vertical fan, the second element is a flabellum of the vertical fan.

FIG. 2 shows that the bottom bracket 11 is annular, and defines a groove 113 on the upper surface 111 of the bottom bracket 11. The groove 113 extends along the circumference of the bottom bracket 11. The top bracket 12 is also annular. The top bracket 12 defines a annular slot 123 on the lower surface 121. The top bracket 12 further defines a groove 124 on the bottom of the slot 123 communicating with the annular slot 123. The annular slot 123 and the groove 124 are both extending along the circumference of the top bracket 12. The cross section of the grooves 113 and 124 are both arc-shaped. The groove 113, the annular slot 123 and the groove 124 are aligned and cooperatively form a receiving space for receiving the spacer 13 and the balls 14.

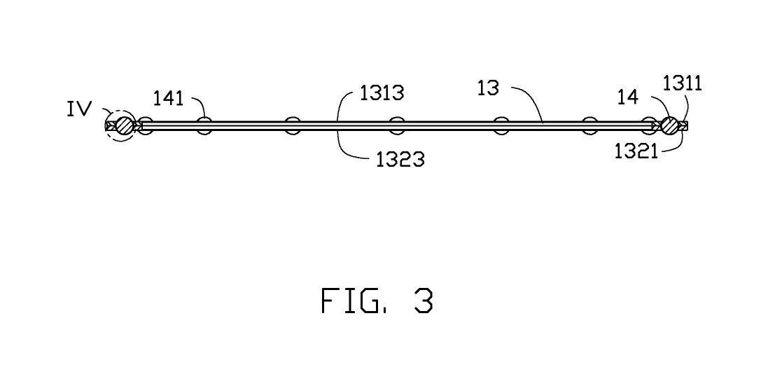

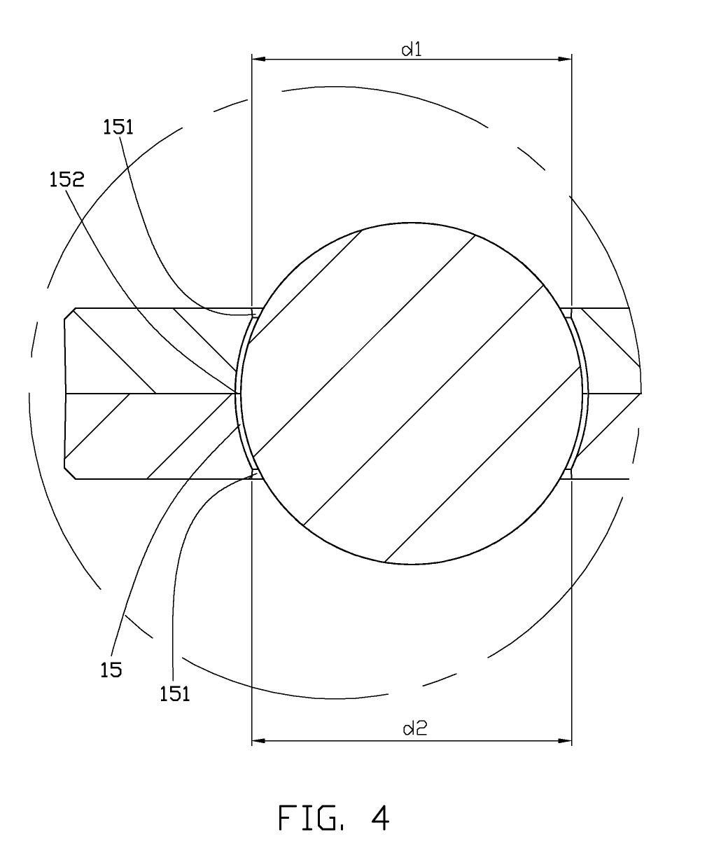

FIGS. 3 and 4 show that the spacer 13 includes a plurality of holding holes 15 for receiving the balls 14; each holding hole 15 has two openings 151 exposed at opposite surfaces 1313 and 1323 of the spacer 13, and a diameter of each of the openings 151 is less than that of the balls 14, and a diameter of a central portion 152 of each holding hole 15 is equal to the diameter of the balls 14; each of the holding holes 15 accommodates one corresponding ball 14, as a thickness of the spacer 13 is less than a diameter of the balls 14, therefore, while a ball 14 is received in a holding hole 15, each ball 14 has opposite end portions 141 protruding out of the spacer 13 and the end portions 141 of the balls 14 are received in the grooves 113 and 124. While the top bracket 12 is rotating with respect to the bottom bracket 11, the balls 14 are also rolling along the groove 113 and 124 and the balls 14 cannot drop from the holding holes 15.

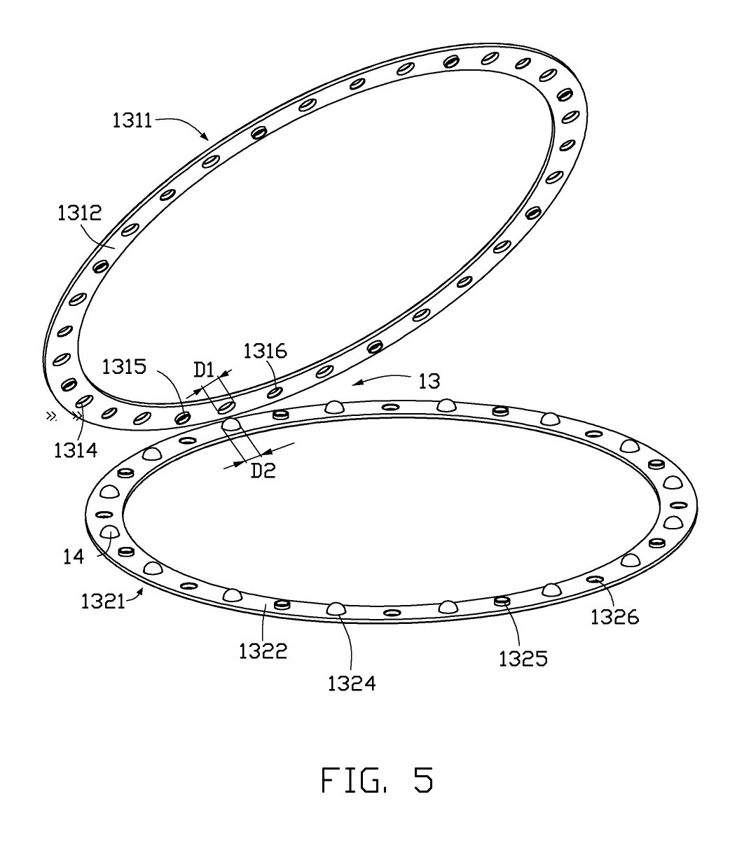

FIGS. 3, 4 and 5 show that in one embodiment, the spacer 13 includes a first sub spacer 1311 and a second sub spacer 1321 attached to the first sub spacer 1311. The second sub spacer 1321 has the same structure as the first sub spacer 1311 and the first sub spacer 1311 engages the second sub spacer 1321 to form the spacer 13. The thickness of the spacer 13 is less than the diameter of the balls 14, the thickness of either the first sub spacer 1311 or the second sub spacer 1321 is less than the radius of the balls 14.

The first sub spacer 1311 includes a first surface 1312 and a second surface 1313 opposite to the first surface 1312. The first sub spacer 1311 defines a plurality of first semi-spherical holes 1314. The first semi-spherical holes 1314 are arranged along the circumference of the first sub spacer 1311 at equal space. The diameter D1 of the first semi-spherical hole 1314 on the first surface 1312 is equal to the diameter of the ball 14. The diameter d1 of the first semi-spherical hole 1314 on the second surface 1313 is less than that of the ball 14. The first sub spacer 1311 also includes a plurality of first locating posts 1315 and a plurality of first locating bores 1316.

The second sub spacer 1321 includes a third surface 1322 and a fourth surface 1323 opposite to the third surface 1322. The second sub spacer 1321 defines a plurality of second semi-spherical holes 1324. The second semi-spherical holes 1324 are arranged along the circumference of the second sub spacer 1321 at equal space. The diameter of the second semi-spherical hole 1324 on the third surface 1322 is equal to the diameter of the ball 14. The diameter of second semi-spherical hole 1324 on the fourth surface 1323 is less than that of the ball 14. The second sub spacer 1321 also defines a plurality of second locating posts 1325 and a plurality of second locating bores 1326. Moreover, the number of the second locating posts 1325 is equal to that of the first locating bores 1316, and the number of the second locating bores 1326 is equal to that of the first locating post 1315.

In this embodiment, the numbers of the first locating posts 1315 and the first locating bores 1316 are both eight, and the number of the first semi-spherical holes 1314 are sixteen. The first locating post 1315, the first semi-spherical hole 1314, the first locating bore 1316 and the first semi-spherical hole 1314 are located on the first sub spacer 1311 at equal space.

The first locating post 1315 is received in the second locating bore 1326, and the second locating post 1325 is received in the first locating bore 1316. Thus, the first sub spacer 1311 and the second sub spacer 1321 are fixed to each other, and the first semi-spherical holes 1314 and the second semi-spherical holes 1324 cooperatively form the holding holes 15 for accommodating the balls 14. While assembling, a ball 14 was firstly received in a first semi-spherical hole 1314, and then turning the second sub spacer 1321 until the first locating posts 1315 of the first sub spacer 1311 are both aligned with the second locating bores 1326 of the second sub spacer 1321 and then engaging the first sub spacer 1311 with the second sub spacer 1321, and the balls 14 are thus held in the holding holes 15.

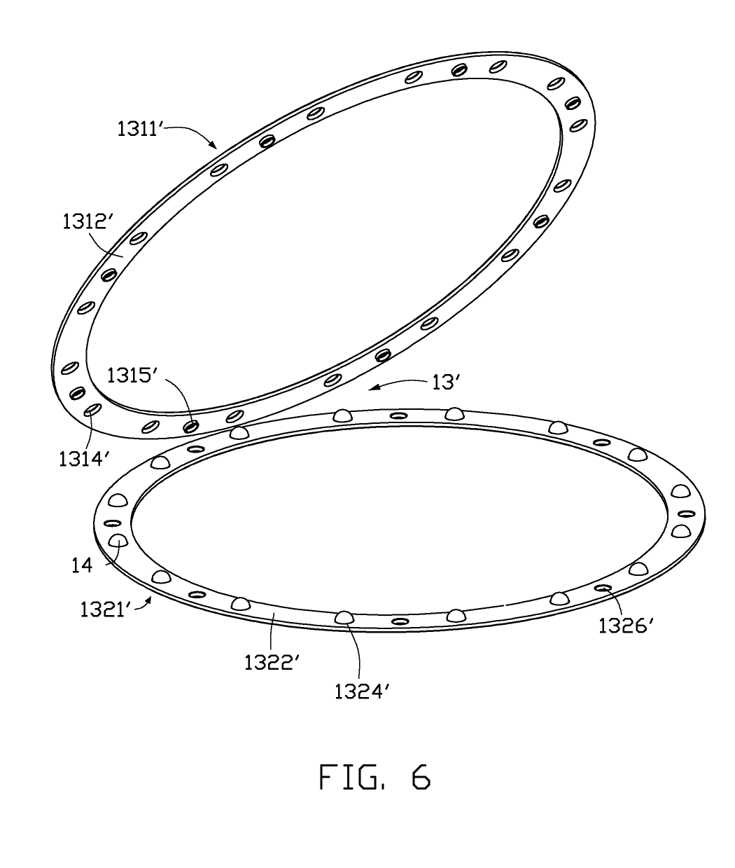

FIG. 6 shows a space 13′ in an alternative embodiment, the space 13′ includes a first sub spacer 1311′ and a second sub spacer 1321′, the first sub spacer 1311′ has a structure different from a structure of the second sub spacer 1321′. The first sub spacer 1311′ includes a plurality of the first locating posts 1315′ and a plurality of the first semi-spherical holes 1314′. The second sub spacer 1321′ defines a plurality of the second locating bores 1326′ and a plurality of the second semi-spherical holes 1324′. The first locating posts 1315′ of the first sub spacer 1311′ engage with the second locating bores 1326′ of the second sub spacer 1321′ to form the spacer 13′, and the first semi-spherical holes 1314′ face the second semi-spherical holes 1324′ to form a plurality of holding holes (not shown) for accommodating the balls 14.

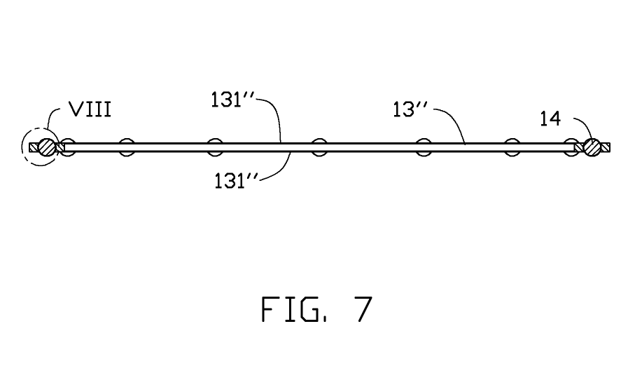

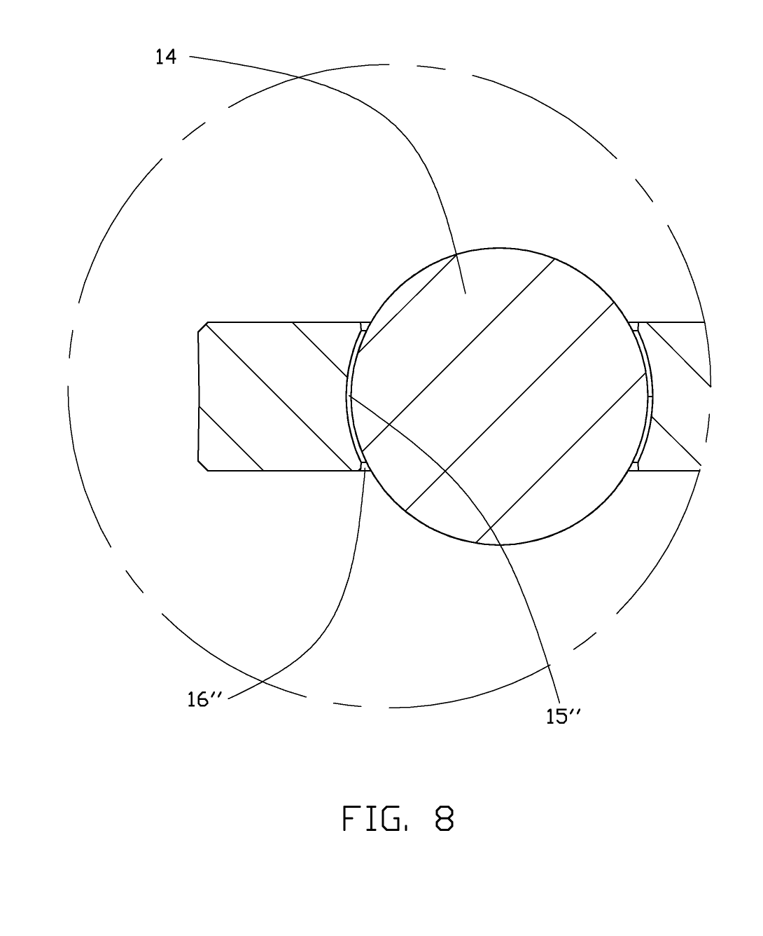

FIGS. 7 and 8 show a spacer 13″ in another alternative embodiment. The spacer 13″ is made of rubber such as thermal plastic rubber. A plurality of holding holes 15″ are defined on the spacer 13″ along the circumference of the spacer 13″ at equal space. Each holding hole 15″ has two openings 16″ exposed at opposite surfaces 131″ of the spacer 13″, The diameter of opening 16″ is less than that of the balls 14. The balls 14 are forced into the holding holes 15″ from the opening 16″of the holding holes 15″ on the surface of the spacer 13″ by external force.

It is to be understood, however, that even though numerous characteristics and advantages of the present disclosure have been set forth in the foregoing description, together with details of the structure and function of the present disclosure, the present disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A rotary connection apparatus comprising
a bottom bracket,
a top bracket rotatably connected to the bottom bracket,
an annular spacer and
a plurality of balls, wherein the spacer and the balls are received between the bottom bracket and the top bracket, wherein a thickness of the spacer is less than a diameter of the balls, and the spacer includes a plurality of holding holes, each holding hole has two openings exposed at opposite surfaces of the spacer, and a diameter of each of the openings is less than that of the balls, and a diameter of a central portion of each holding hole is equal to the diameter of the balls; each of the holding holes accommodates one corresponding ball, and each ball has opposite end portions protruding out of the spacer.

2. The rotary connection apparatus of claim 1, wherein each holding hole is spherical.

3. The rotary connection apparatus of claim 1, wherein the spacer includes a first sub spacer and a second sub spacer attached to the first sub spacer, and the first sub spacer includes a plurality of first locating posts and defines a plurality of first semi-spherical holes, and the second sub spacer defines a plurality of second locating bores and a plurality of semi-spherical holes; the first locating posts of the first sub spacer engage in the second locating bores, and the first semi-spherical holes are aligned with the second semi-spherical holes, the first and second semi-spherical holes cooperatively form the holding holes.

4. The rotary connection apparatus of claim 3, wherein the first sub spacer defines a plurality of first locating bores, and the second sub spacer includes a plurality of second locating posts, and the first locating bores of the first sub spacer are engaged with the second locating posts of the second sub spacer.

5. The rotary connection apparatus of claim 1, wherein the spacer is made of thermal plastic rubber.

6. The rotary connection apparatus of claim 1, wherein the spacer is made of rubber.

7. The rotary connection apparatus of claim 1, wherein each of the bottom bracket and the top bracket includes a groove for receiving the corresponding end portions of the balls.

8. A spacer, comprising:
a first sub spacer and a second sub spacer, wherein the first sub spacer includes a plurality of posts and defines a plurality of first semi-spherical holes, and the second sub spacer defines a plurality of bores and a plurality of second semi-spherical holes; the posts of the first sub spacer inserted in the bores, and the first semi-spherical holes aligned with the second semi-spherical holes such that the first and second semi-spherical holes cooperatively form a plurality of the spherical holding holes.

9. The spacer of claim 8, further comprising a plurality of balls received in the holding holes.
